(19) United States
(12) Patent Application Publication
(10) Pub. No.: US 2006/0251325 A1
(43) Pub. Date: Nov. 9, 2006

(54) Particle filter based vessel segmentation

(76) Inventors: Charles Florin, Princeton, NJ (US); James P. Williams, Princeton Junction, NJ (US); Nikolaos Paragios, Vincennes (FR)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/265,586

(22) Filed: Nov. 2, 2005

Related U.S. Application Data
(60) Provisional application No. 60/625,907, filed on Nov. 8, 2004.

(51) Int. Cl. G06K 9/34

(52) U.S. Cl. 382/173

(57) ABSTRACT

A system and method for particle filter based vessel segmentation are provided, the system including a processor, a Particle Filter unit in signal communication with the processor, and a Vessel Segmentation unit in signal communication with the processor; and the method including receiving image data for a vessel, initializing the vessel, modeling successive planes of the vessel as unknown states of a sequential process, and using a Particle Filter with a Monte Carlo sampling rule to propagate a plurality of segmentation hypotheses in parallel.

### CROSS-REFERENCE TO RELATED APPLICATION

This application claims the benefit of U.S. Provisional Application Ser. No. 60/625,907 (Attorney Docket No. 2004P18906US), filed Nov. 8, 2004 and entitled “Particle Filters for Coronary Arteries Segmentation”, which is incorporated herein by reference in its entirety.

### BACKGROUND

Cardiovascular diseases are leading causes of death in the United States. Thus, there is a great demand for improved diagnostic tools to detect and measure anomalies in the cardiac muscle. Coronary arteries are thin vessels that feed the heart muscle with blood. Therefore, their segmentation provides a valuable diagnostic tool for clinicians interested in detecting calcifications and stenoses. Because of low-contrast conditions and the coronaries vicinity to the blood pool, segmentation is a difficult task. Computed Tomography (CT) and Magnetic Resonance (MR) imaging of the heart have become standard tools for medical diagnosis, resulting in a substantial number of patients being imaged.

Vessel segmentation techniques include model-free and model-based methods. Vessel enhancement approaches and differential geometry-driven methods do not segment vessels per se, but allow a better visualization. Region growing, flux maximization, morphological operators and skeleton-based techniques are more advanced vessel segmentation techniques.

Model-based techniques use prior knowledge and features to match a model with the input image and extract the vessels. Prior knowledge refers either to the whole structure or to the local vessel model. Tracking approaches recover the vessel centerline, given a starting condition, through processing information on the vessel cross section. Vessel template matching, generalized cylindrical models, as well as parametric and/or geometric deformable models are alternatives to vessel tracking and seek to minimize an objective function computed along the model. Level sets provide an established method to address such minimization. One can refer to the fast marching algorithm and its variant for vessel segmentation using the minimal path principle. To discourage leaking, a local shape term that constrains the diameter of the vessel has been proposed.

Existing approaches suffer from certain limitations. Local operators, region growing techniques, morphological filters as well as geometric contours might be very sensitive to local minima and fail to take into account prior knowledge on the form of the vessel. In addition, cylindrical models, parametric active contours and template matching techniques may not be well suited to account for the non-linearity of the vessel structure, and require particular handling of branchings and bifurcations. Tracking methods can often fail in the presence of missing and corrupted data, or sudden changes. Level sets are computationally time-consuming, and the Fast Marching algorithm loses local implicit function properties.

### SUMMARY

These and other drawbacks and disadvantages of the prior art are addressed by an exemplary system and method for particle filter based vessel segmentation.

An exemplary system for particle filter based vessel segmentation includes a processor; a Particle Filter unit in signal communication with the processor for modeling successive planes of a vessel as unknown states of a sequential process with a Monte Carlo sampling rule to propagate a plurality of segmentation hypotheses in parallel; and a Vessel Segmentation unit in signal communication with the processor for selecting one of the plurality of segmentation hypotheses responsive to a probability density function and segmenting the image data in accordance with the selected segmentation hypothesis.

An exemplary method for particle filter based vessel segmentation includes receiving image data for at least one vessel; initializing the at least one vessel; modeling successive planes of the at least one vessel as unknown states of a sequential process; and using a Particle Filter with a Monte Carlo sampling rule to propagate a plurality of segmentation hypotheses in parallel.

An exemplary program storage device for particle filter based vessel segmentation includes program steps for receiving image data for at least one vessel; initializing the at least one vessel; modeling successive planes of the at least one vessel as unknown states of a sequential process; and using a Particle Filter with a Monte Carlo sampling rule to propagate a plurality of segmentation hypotheses in parallel.

These and other aspects, features and advantages of the present disclosure will become apparent from the following description of exemplary embodiments, which is to be read in connection with the accompanying drawings.

### BRIEF DESCRIPTION OF THE DRAWINGS

The present disclosure teaches a system and method for particle filter based vessel segmentation in accordance with the following exemplary figures, in which:

FIG. 1 shows a schematic diagram of a system for particle filter based vessel segmentation in accordance with an illustrative embodiment of the present disclosure;

FIG. 2 shows a flow diagram of a method for particle filter based vessel segmentation in accordance with an illustrative embodiment of the present disclosure;

FIG. 3 shows a graphical diagram of image data with calcification, stent or high intensity prosthesis, branching with obtuse angles, and stenosis or sudden reduction of vessel cross-section diameter;

FIG. 4 shows a graphical diagram of image data with branching points between LCX and LAD for three patients with the particles' mean state overlaid, and the particles, clustered using K-means, following up the two branches; and

FIG. 5 shows a graphical diagram of image data with a full view of a heart, and segmentation of the Left Anterior Descending Coronary Artery and Right Coronary Artery in computed tomographic angiography (CTA) for four patients.

### DETAILED DESCRIPTION OF PREFERRED EMBODIMENTS

The present disclosure provides a particle filter based approach for the segmentation of vessels. Exemplary embodiments of the present disclosure are particularly useful for segmenting coronary arteries. The disclosure motivates vessel segmentation, introduces an approach using particle filters, and presents vessel segmentation embodiments covering both implementation and validation.

In an exemplary embodiment, successive planes of a vessel are modeled as unknown states of a sequential process. Such states include the orientation, position, shape model and appearance, in statistical terms, of a vessel that are recovered in an incremental fashion using a sequential Bayesian filter or Particle Filter. In order to account for bifurcations and branchings, a Monte Carlo sampling rule is used, which propagates in parallel multiple hypotheses. Successful results on the segmentation of coronary arteries demonstrate the potential of the approach.

A particle-based approach to vessel segmentation is provided where the problem of recovering successive planes of the vessel in a probabilistic fashion with numerous possible states is re-formulated. The problem of vessel segmentation may be considered as a tracking problem of tubular structures in 3D volumes. Thus, given a starting position, a feature vector is considered, which upon its successful propagation, provides a complete segmentation of the coronaries. In the presently disclosed technique, unlike standard techniques where only the most probable hypothesis is maintained, a discrete number of states or possible solutions remain active and are associated with a probability density function (pdf). The final paradigm includes a fast multiple hypothesis adaptive propagation technique where the vessel structure and its appearance are successfully recovered. Such a framework naturally addresses the non-linearities of the geometry, as well as the appearance of coronaries.

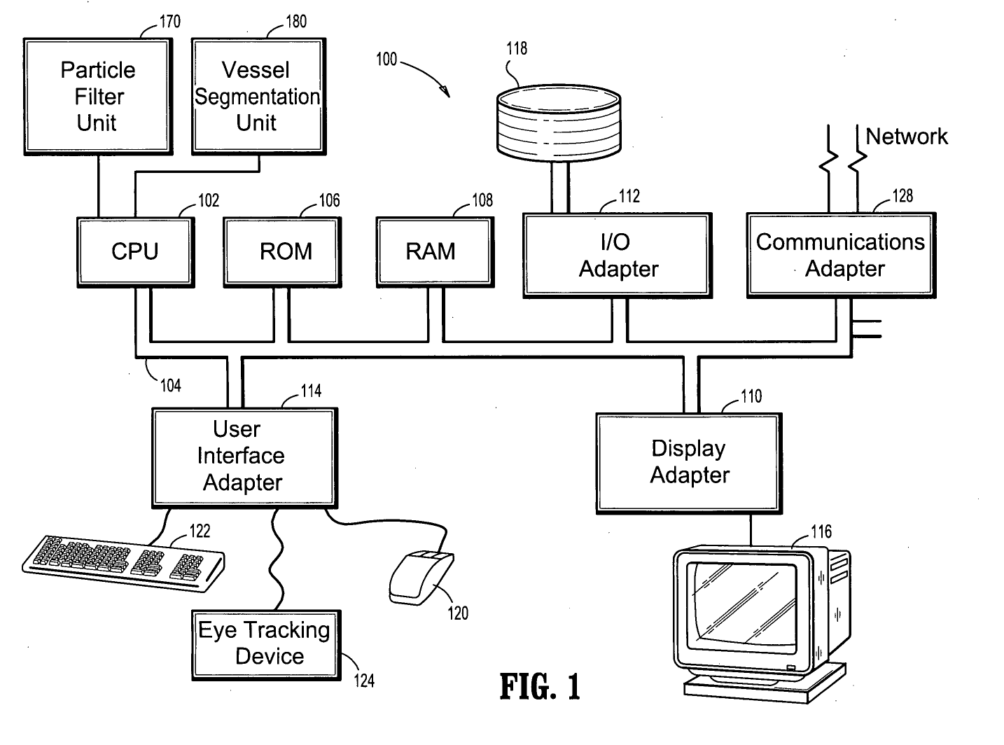

As shown in FIG. 1, a system for particle filter based segmentation, according to an illustrative embodiment of the present disclosure, is indicated generally by the reference numeral 100. The system 100 includes at least one processor or central processing unit (CPU) 102 in signal communication with a system bus 104. A read only memory (ROM) 106, a random access memory (RAM) 108, a display adapter 110, an I/O adapter 112, a user interface adapter 114, a communications adapter 128, and an imaging adapter 130 are also in signal communication with the system bus 104. A display unit 116 is in signal communication with the system bus 104 via the display adapter 110. A disk storage unit 118, such as, for example, a magnetic or optical disk storage unit is in signal communication with the system bus 104 via the I/O adapter 112. A mouse 120, a keyboard 122, and an eye tracking device 124 are in signal communication with the system bus 104 via the user interface adapter 114. An imaging device 132 is in signal communication with the system bus 104 via the imaging adapter 130.

A particle filter unit 170 and a vessel segmentation unit 180 are also included in the system 100 and in signal communication with the CPU 102 and the system bus 104. While the particle filter unit 170 and the vessel segmentation unit 180 are illustrated as coupled to the at least one processor or CPU 102, these components are preferably embodied in computer program code stored in at least one of the memories 106, 108 and 118, wherein the computer program code is executed by the CPU 102.

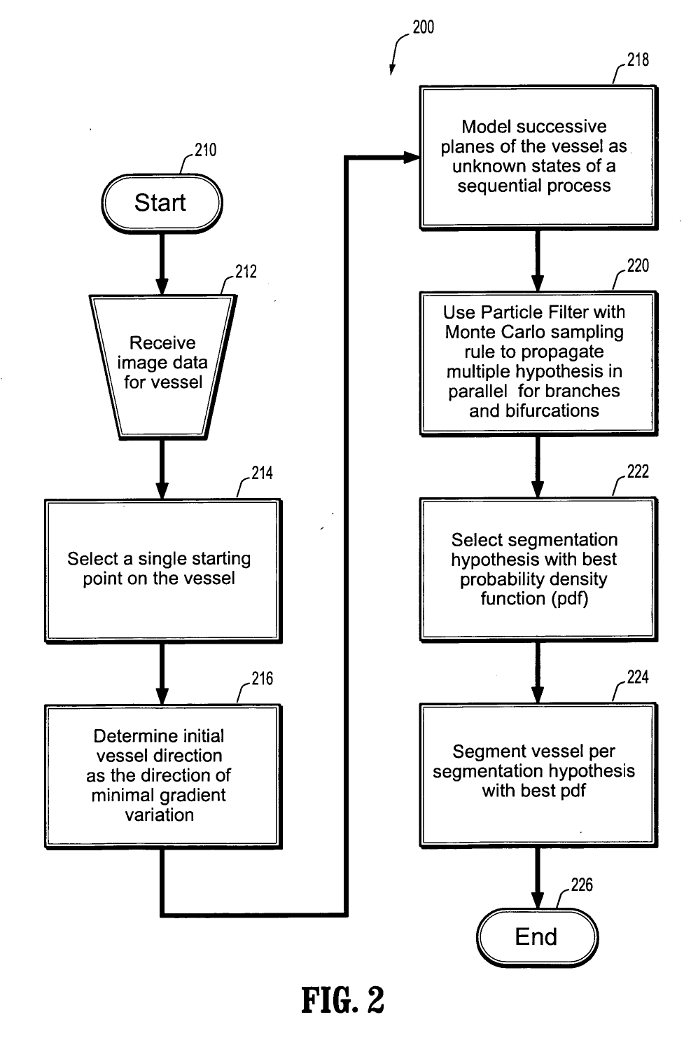

Turning to FIG. 2, a method for particle filter based segmentation, according to an illustrative embodiment of the present disclosure, is indicated generally by the reference numeral 200. Here, a start block 210 passes control to an input block 212. The input block 212 receives image data for vessel, and passes control to a function block 214. The function block 214 selects a single starting point on the vessel, and passes control to a function block 216. The function block 216, in turn, determines the initial vessel direction as the direction of minimal gradient variation, and passes control to a function block 218. The function block 218 models successive planes of the vessel as unknown states of a sequential process, and passes control to a function block 220. The function block 220 uses a Particle Filter with a Monte Carlo sampling rule to propagate multiple hypotheses in parallel for branches and bifurcations, and passes control to a function block 222. The function block 222, in turn, selects the segmentation hypothesis with the best probability density function (pdf), and passes control to a function block 224. The function block 224 segments the vessel per the segmentation hypothesis having the best pdf, and passes control to an end block 226. Thus, the function block 224 selects one best hypothesis and segments the vessel accordingly. This is only one possible use of the probability density function (pdf). In an alternate embodiment, the pdf may be used to determine the weighted mean of all hypotheses, which is a more robust technique than selecting one best hypothesis. In another alternate embodiment, the pdf may be used to compute the standard deviation, which may in turn be used as a degree of confidence in the segmentation.

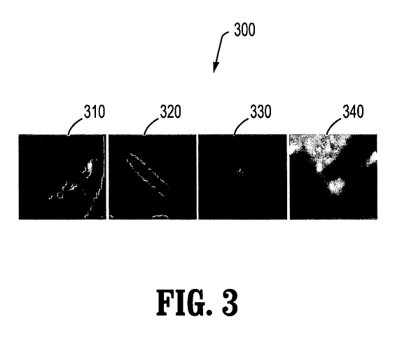

Turning now to FIG. 3, image data according to an illustrative embodiment of the present disclosure is indicated generally by the reference numeral 300. The image data 300 includes image data with calcification 310, image data with stent or high intensity prosthesis 320, image data having branching with obtuse angles 330, and image data with stenosis or sudden reduction of vessel cross section diameter 340.

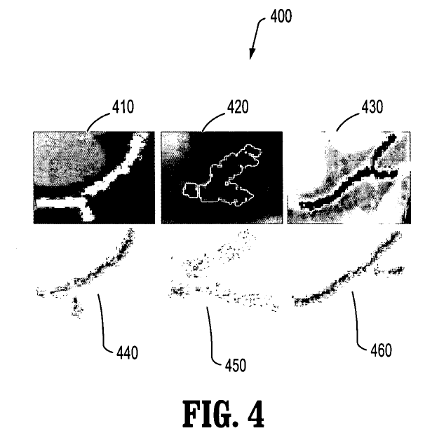

As shown in FIG. 4, image data according to an illustrative embodiment of the present disclosure is indicated generally by the reference numeral 400. The image data 400 includes image data 410, 420 and 430 with branching points between LCX and LAD for three patients, respectively, and image data 440, 450 and 460 for the three patients with the particles' mean state overlaid with the particles, clustered using K-means or any other clustering technique, and following up the two branches.

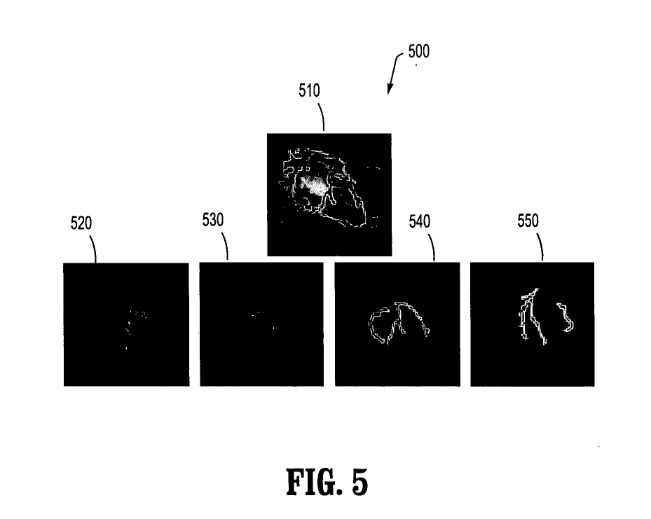

Turning to FIG. 5, image data according to an illustrative embodiment of the present disclosure is indicated generally by the reference numeral 500. The image data 500 includes image data 510 of a full view of a heart, and image data 520, 530, 540 and 550 with segmentation of the Left Anterior Descending Coronary Artery and Right Coronary Artery in CTA for four patients, respectively.

At a conceptual level, the presently disclosed method may be better understood as follows. Assume that a segment of the vessel has been detected: a 2D shape on a 3D plane. Similar to region growing and front propagation techniques, the present method aims to segment the vessel in adjacent planes. To this end, one can consider the hypotheses (ω) of the vessel being at a certain location (x), having certain orientation (Θ), and referring to certain shape, where an elliptic model is a common choice (ε), with certain appearance characteristics (pᵥₑₛₛₑₗ).

$$ω = ( \underbrace{x = ( {x}_{1} , {x}_{2} , {x}_{3} )}_{positon} , \underbrace{Θ = ( {θ}_{1} , {θ}_{2} , {θ}_{3} )}_{orientation} , \underbrace{ε = ( α , β , ϕ )}_{shape} , \underbrace{{p}_{vessel}}_{appearance} )$$

Then, segmentation includes finding the optimal parameters of ω given the observed 3D volume. Let us consider a probabilistic interpretation of the problem with π(ω) being the posterior distribution that measures the fitness of the vector ω with the observation. Under the assumption that such a law is present, segmentation includes finding at each step the set of parameters ω that maximizes π(ω). However, since such a model is unknown, one can assume an autoregressive mechanism that, given prior knowledge, predicts the actual position of the vessel and a sequential estimate of its corresponding states. To this end, a state and/or feature vector ω is defined. An iterative process is used to predict the next state and update the density function using a Bayes sequential estimator, and is based on the computation of the present state ωₜ probability density function (pdf) of a system using observations from time 1 to time t z_{1:t}:π(ωₜ|z_{1:t}. Assuming that one has access to the prior pdf π(ωₜ₋₁|z_{1:t-1}), the posterior pdf π(wₜ|z_{1:t}) is computed according to Bayes rule:

$$π ( {ω}_{t} \vert {z}_{1 : t} ) = \frac{π ( {z}_{t} \vert {ω}_{t} ) π ( {ω}_{t} \vert {z}_{1 : t - 1} )}{π ( {z}_{t} \vert {z}_{1 : t - 1} )} .$$

The recursive computation of the prior and the posterior pdf leads to the exact computation of the posterior density, a distance between prediction and actual observation, based on the observation. A Kalman filter is a variant of this model, and provides a linear approach capable of tracking vessels with limited variation in appearance and geometry. Cardiac vessel trees are highly irregular. Random bifurcations, branches of variable width, non-linear visual properties because of the presence of calcifications, stents, stenosis and diseased vessel lumen are some examples demonstrating the non-linearity of the vessel tree as in FIG. 3.

Consequently, simple parametric statistical models will fail to account for the statistical and geometric properties of the vessel, leading to the consideration of more complex distributions. To this end, instead of one single prediction, a collection of hypotheses can be generated at each step and be evaluated using the distance between prediction and actual observation. In many practical cases, it is impossible to compute exactly the posterior pdf π(ωₜ|z_{1:t}), which is to be approximated. An elegant approach to implement such a technique refers to the use of particle filters where each given hypothesis is a state in the feature space, or particle, and the collection of hypothesis is a sampling of the feature space.

Particle Filters are sequential Monte-Carlo techniques that are used to estimate the Bayesian posterior probability density functions. In terms of a mathematical formulation, such a method approximates the posterior pdf by M random measures {ωₜ^{m},m=1 . . . M} associated with M weights {λₜ^{m}, m=1 . . . m}, such that

$$π ( {ω}_{t} \vert {z}_{1 : t} ) \approx {\sum }_{m = 1}^{M} {λ}_{t}^{m} δ ( {ω}_{t} - {ω}_{t}^{m} ) , \qquad ( 1 )$$

where each weight λₜ^{m} reflects the importance of the sample ωₜ^{m} in the pdf. The samples ωₜ^{m} are drawn using the principle of Importance Density, of pdf q(ωₜ|x_{1:t}^{m},zₜ), and it is shown that their weights λₜ^{m} are updated according to

$${λ}_{t}^{m} ∝ {λ}_{t - 1}^{m} \frac{π ( {z}_{t} \vert {ω}_{t}^{m} ) π ( {ω}_{t}^{m} \vert {ω}_{t - 1}^{m} )}{q ( {ω}_{t}^{m} \vert {ω}_{t - 1}^{m} , {z}_{t} )} . \qquad ( 2 )$$

Once a set of samples has been drawn, π(ωₜ^{m}|ωₜ₋₁^{m};zₜ) can be computed out of the observation zₜ for each sample, and the estimation of the posteriori pdf can be sequentially updated.

Consider the application of such a non-linear model to vessel segmentation and tracking. Without loss of generality, one can assume that the root of a coronary is known, whether provided by a user or through some prior automatic procedure. Simple segmentation of that area can provide an initial estimate on the statistical properties of the vessel appearance. It is reasonable to assume irregularity in the appearance pᵥₑₛₛₑₗ of the vessel because of the presence of calcifications, stents, stenosis and diseased vessel lumen, as in FIG. 3. Therefore, simple parametric statistical models on the appearance space will fail to account for the statistical properties of the vessel, and more complex distributions are to be considered. Consider a Gaussian mixture model that consists of two components to represent the evolving distribution of the vessel, the contrast enhanced blood (P_{B},μ_{B},σ_{B}) and the high density components, such as calcifications or stent, (P_{C},μ_{C}σ_{C}) subject to the constraint |\dot{P}_{C}+\dot{P}_{B}=1| leading to the following state vector:
ω=(x,Θ,ε,(P_{B},μ_{B},σ_{B}),(P_{C},μ_{C},σ_{C})) (3)

The vessel state vector consists of the 3D location of the vessel x, the tangent vector Θ, its shape model at a given cross-section, where the model used here is an ellipse with α (major axis radius), β (minor axis radius), φ (orientation), and the appearance pᵥₑₛₛₑₗ, mixture of two Gaussians.

Once such a recursive paradigm is built, the issue to be addressed is the definition of a measure between a prediction and the actual observation. To this end, the image terms are mostly used, and in particular the intensities that do correspond to the vessel in the current cross-section. The observed distribution of this set is approximated using a Gaussian mixture model according to the expectation-maximization principle.

Now consider a random state vector ω, which refers to a certain segmentation hypothesis that is to be evaluated (p(ω|D)) where D is the observed 3D volume. Such a hypothesis should refer to a region that has consistent visual properties with the ones expected (pᵥₑₛₛₑₗ). While the separation of the vessels from the cardiac muscle is a rather tedious task since blood is present in both organs, their separation from the liquid of the vascular structure is possible and can be used to validate the goodness or quality of a hypothesis.

For the vessel lumen pixels distribution pᵥₑₛₛₑₗ, the probability is measured as the distance between the hypothesized distribution and the distribution actually observed. The distance used here is the symmetrized Kullback-Leibler distance Dₐₚ between the model p(ω)=pᵥₑₛₛₑₗ and the observation q(ω):

$${D}_{ap} = \int p ( ω ) log ( \frac{p ( ω )}{q ( ω )} ) + q ( ω ) log ( \frac{q ( ω )}{p ( ω )} ) ⅆ ω ,$$

which have important values when the distance between these two distributions is significant. Therefore, one can consider the following measure

$$[ p ( ω \vert {D}_{ap} ) = {ⅇ}^{- \frac{\vert {D}_{ap} \vert}{{σ}_{ap}}} ]$$

where σₐₚ is a normalization factor. Toward discriminating the vessel from the vascular liquid, one can consider a ribbon measure

$${D}_{rb} = \{ \begin{matrix}- ∞ , & {μ}_{int} \leq {μ}_{ext} \\ \frac{{μ}_{int} - {μ}_{ext}}{{μ}_{int} + {μ}_{ext}} , & otherwise\end{matrix}$$

where μᵢₙ is the mean within the ellipse and μₑₓₜ is the mean within a ring centered at the ellipse center with greater radius, where the ring area is equal to the inner circle area. Such a measure aims at maximizing the distance between the mean values of the interior and the exterior region, based on the fact that the coronary arteries are brighter than the background, and can also be used to measure the fitness of the segmentation:

$$[ p ( ω \vert {D}_{rb} ) = {ⅇ}^{- \frac{\vert {D}_{rb} \vert}{{σ}_{rb}}} ] .$$

It may be assumed that the two conditions are independent, and therefore one can multiply the two measures to determine the goodness or quality of the hypothesis under consideration.

Given a starting point and a number of particles, one now performs random perturbations to each particle in the feature space. Once a perturbation has been applied, the corresponding hypothesis is evaluated using the visual matching and the ribbon measure introduced earlier. At each step of the process, segmentation refers to a weighted linear combination of the state vectors or particles, as set forth in Equation 1.

Such a process will remove most of the particles after enough iterations, and only the ones that express the data will present significant weights. Consequently the model will lose its ability to track significant changes on the pdf. At the same time, in the presence of bifurcations, new hypotheses are to be introduced in order to capture the entire vessel tree. Therefore, a resampling procedure is executed on a regular basis. Such a process will preserve as many samples as possible with respectful weights. There are a number of resampling techniques in the literature. The most prominent one, Sampling Importance Resampling, is chosen here for its simplicity to implement, and because it allows more hypothesis with low probability to survive when compared to more selective techniques such as Stratified Resampling.

The Sampling Importance Resampling (SIR) algorithm includes choosing the prior density π(ωₜ|ωₜ₋₁) as importance density q(ωₜ|_{1:t}^{m},zₜ [symbol] ). This leads to the following condition from Equation 2: λₜ^{m}∝λₜ₋₁^{m}π(zₜ|ωₜ^{m}).

The samples are updated by setting ωₜ^{m}∝π(ωₜ|ωₜ₋₁^{m}), and perturbed according to a random noise vector. The SIR algorithm is the most widely used resampling method because of its simplicity from an implementation point of view. Nevertheless, the SIR uses mostly the prior knowledge π(ωₜ|ωₜ₋₁) and does not take into account the most recent observations zₜ. Such a strategy could lead to an overestimation of outliers. On the other hand, because SIR resampling is performed at each step, fewer samples are required, and thus the computational cost may be reduced with respect to other resampling algorithms.

Particular attention is also to be paid during the resampling process to address branching and bifurcations. When a branching occurs, the particles split up in the two daughter branches, and then they are tracked separately as in FIG. 5. Although Particle Filters track the two branches, experiments have shown that branching detection heuristics improve the results. To this end, a simple K-means approach on the joint space, position and orientation of the particles is considered. When the two clusters are well separated, the number of particles is doubled and equally dispatched in the two branches.

Regarding the initial configuration, the use of approximately 1,000 particles gave sufficient results for experiments. A systematic resampling is performed according to the Sampling Importance Resampling when the effective sampling size N_{eff}=Σᵢ1/λᵢ² (where λᵢ is the weight of the i^{th} particle) falls below half the number of particles. The preference for SIR, compared to Stratified Resampling, is for the robustness of the segmentation.

A particle-filter based approach to vascular segmentation is described above. Experiments were conducted on several patients computed tomographic angiography (CTA) data sets, segmenting both the Left Main Coronary Artery and the Right Coronary Artery. Validation is a challenging but required step for any coronary segmentation method. The algorithm has been evaluated on 34 patients, and has successfully recovered all the main arteries (RCA, LAD, LCX) for each patient as shown in the following table:

| | | Acute | | | | Obtuse |
|---|---|---|---|---|---|---|
| vessel name | RCA | Marginal | LAD | First Septal | LCX | Marginal |
| % of cases | 100% | 85.3% | 100% | 94% | 100% | 94% |
| segmented | | | | | | |

Small portions of visual results are also presented in FIG. 5. The above table indicates the number of branches, in percentage, that were successfully segmented. These results were achieved with a simple one-click initialization. From the first point provided by the user, the initial direction is determined as the direction of minimal gradient variation. All patients presented some type of artery pathology in at least one of their coronary vessels. The Particle Filter successfully segmented both healthy and unhealthy coronaries. The method successfully detects all the main branchings, while in some cases smaller branchings at the lowest parts of the vessel tree were missed. However, the clinical use of such smaller branchings at the lowest parts of the vessel tree is of lower importance.

Accordingly, Particle Filters can be used for vascular segmentation. In the context of vascular segmentation, Particle Filters sequentially estimate the probability density function (pdf) of segmentations in a particular feature space. The case of coronary arteries was considered to validate such an approach, where the ability to handle discontinuities was demonstrated on the structural space, such as for branching, as well as on the appearance space, such as for calcifications, pathological cases, and the like. A significant advantage of such methods is the non-linearity assumption on the evolution of samples. The use of an image term and a statistical model makes the probability measure robust to pathologies, and also drives the segmentation toward the most probable solution given the statistical prior. Alternate method embodiments may address learning the variation law that rules the feature space toward better tests for hypotheses validation, as well as the one that controls process noise, to better guide the resampling stage toward an intelligent reduction of the required number of particles.

In alternate embodiments of the apparatus 100, some or all of the computer program code may be stored in registers located on the processor chip 102. In addition, various alternate configurations and implementations of the particle filter unit 170 and the vessel segmentation unit 180 may be made, as well as of the other elements of the system 100. In addition, the methods of the present disclosure can be performed in color or in gray level.

It is to be understood that the teachings of the present disclosure may be implemented in various forms of hardware, software, firmware, special purpose processors, or combinations thereof. Most preferably, the teachings of the present disclosure are implemented as a combination of hardware and software.

Moreover, the software is preferably implemented as an application program tangibly embodied on a program storage unit. The application program may be uploaded to, and executed by, a machine comprising any suitable architecture. Preferably, the machine is implemented on a computer platform having hardware such as one or more central processing units (CPU), a random access memory (RAM), and input/output (I/O) interfaces.

The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present disclosure is programmed. Given the teachings herein, one of ordinary skill in the pertinent art will be able to contemplate these and similar implementations or configurations of the present disclosure.

Although illustrative embodiments have been described herein with reference to the accompanying drawings, it is to be understood that the present disclosure is not limited to those precise embodiments, and that various changes and modifications may be effected therein by one of ordinary skill in the pertinent art without departing from the scope or spirit of the present disclosure. All such changes and modifications are intended to be included within the scope of the present disclosure as set forth in the appended claims.

What is claimed is:

1. A method for particle filter based vessel segmentation comprising:
receiving image data for at least one vessel;
initializing the at least one vessel;
modeling successive planes of the at least one vessel as unknown states of a sequential process; and
using a Particle Filter with a Monte Carlo sampling rule to propagate a plurality of segmentation hypotheses in parallel.

2. A method as defined in claim 1 wherein parallel segmentation hypotheses are created for branches and bifurcations.

3. A method as defined in claim 1, further comprising selecting one of the plurality of segmentation hypotheses responsive to a probability density function.

4. A method as defined in claim 1, further comprising segmenting the image data in accordance with the segmentation hypothesis having the highest overall probability in accordance with a probability density function.

5. A method as defined in claim 4 wherein the probability density function is a Bayesian posterior probability density function.

6. A method as defined in claim 1, further comprising segmenting the image data in accordance with a weighted mean of the plurality of hypotheses where the weighting is responsive to a probability density function.

7. A method as defined in claim 1, further comprising segmenting the image data in response to a computed standard deviation of a probability density function, where the standard deviation is used as a degree of confidence in the segmentation.

8. A method as defined in claim 1 wherein the at least one vessel is a coronary artery.

9. A method as defined in claim 1, initializing the at least one vessel comprising:
selecting a single starting point on the at least one vessel; and
determining the initial vessel direction as the direction of minimal gradient variation.

10. A method as defined in claim 1, initializing the at least one vessel comprising detecting a segment of the vessel as a 2D shape on a 3D plane.

11. A method as defined in claim 1 wherein each given hypothesis of the plurality of hypotheses is a state in the feature space, or a particle.

12. A method as defined in claim 11 wherein the plurality of hypotheses comprises a sampling of the feature space.

13. A method as defined in claim 1, the Particle Filter comprising a sequential Monte-Carlo algorithm to estimate Bayesian posterior probability density functions.

14. A method as defined in claim 1 wherein the image data includes at least one of calcification, stent or high intensity prosthesis, branching with obtuse angles, or stenosis or sudden reduction of vessel cross section diameter.

15. A method as defined in claim 1, the image data comprising computed tomographic angiography (CTA) data.

16. A method as defined in claim 1 wherein the states include the orientation, position, shape model and appearance, in statistical terms, of a vessel that are recovered in an incremental fashion using a sequential Bayesian filter or Particle Filter.

17. A method as defined in claim 1, vessel segmentation comprising tracking tubular structures in 3D volumes.

18. A system for particle filter based vessel segmentation comprising:
a processor;
a Particle Filter unit in signal communication with the processor for modeling successive planes of a vessel as unknown states of a sequential process with a Monte Carlo sampling rule to propagate a plurality of segmentation hypotheses in parallel; and
a Vessel Segmentation unit in signal communication with the processor for selecting one of the plurality of segmentation hypotheses responsive to a probability density function and segmenting the image data in accordance with the selected segmentation hypothesis.

19. A system as defined in claim 18, further comprising at least one of an imaging adapter and a communications adapter in signal communication with the processor for receiving image data.

20. A system as defined in claim 18, further comprising at least one memory in signal communication with the processor for storing the plurality of segmentation hypotheses.

21. A system as defined in claim 20 wherein the at least one memory has a tree structure for storing the plurality of segmentation hypotheses.

22. A program storage device readable by machine, tangibly embodying a program of instructions executable by the machine to perform program steps for particle filter based vessel segmentation, the program steps comprising:
receiving image data for at least one vessel;
initializing the at least one vessel;
modeling successive planes of the at least one vessel as unknown states of a sequential process; and
using a Particle Filter with a Monte Carlo sampling rule to propagate a plurality of segmentation hypotheses in parallel.
